(19) United States
(12) Patent Application Publication
(10) Pub. No.: US 2021/0234326 A1
(43) Pub. Date: Jul. 29, 2021

(54) INTERMODE LOSS DIFFERENCE COMPENSATION FIBER, OPTICAL AMPLIFIER, AND TRANSMISSION PATH DESIGN METHOD

(71) Applicant: NIPPON TELEGRAPH AND TELEPHONE CORPORATION, Tokyo (JP)

(72) Inventors: Yoko YAMASHITA, Musashino-shi, Tokyo (JP); Masaki WADA, Musashino-shi, Tokyo (JP); Takashi MATSUI, Musashino-shi, Tokyo (JP); Kazuhide NAKAJIMA, Musashino-shi, Tokyo (JP)

(73) Assignee: NIPPON TELEGRAPH AND TELEPHONE CORPORATION, Tokyo (JP)

(21) Appl. No.: 17/266,181

(22) PCT Filed: Aug. 6, 2019
(86) PCT No.: PCT/JP2019/030877

§ 371 Date: Feb. 5, 2021

(30) Foreign Application Priority Data
Aug. 7, 2018 (JP) 2018-148082

(51) Int. Cl. H01S 3/067; G02B 27/00

(52) U.S. Cl. CPC H01S 3/06729; G02B 27/0012

(57) ABSTRACT

Provided is a differential modal attenuation compensation fiber that has a simple structure and can reduce MDL while eliminating the need for precise alignment work, an optical amplifier, and a transmission line design method. The differential modal attenuation compensation fiber according to the present invention, imparts excess loss to a desired propagation mode by forming a cavity portion or a ring-shaped high refractive index portion in a core of an optical fiber. By forming the cavity portion or the ring-shaped high refractive index portion in a part of the profile of the core, electric field distribution of a particular mode propagating through the fiber can be controlled, and different losses can be imparted to different propagation modes at an interface between the cavity portion or the ring-shaped high refractive index portion and a region not including the cavity portion or the ring-shaped high refractive index portion.

### TECHNICAL FIELD

The present disclosure relates to a differential modal attenuation compensation fiber, an optical amplifier, and a transmission line design method that compensates for differential modal gain of signal light propagated through a transmission line.

### BACKGROUND ART

In recent years, Internet traffic has increased because of an increase in the number of services available. Transmission capacity has also dramatically increased due to higher transmission speeds and more wavelength multiplexing using Wavelength Division Multiplexing (WDM) technology. Transmission capacity is expected to further increase with digital coherent technology, which has been actively studied in the past few years. Digital coherent transmission systems have improved spectral efficiency through the use of multi-phase modulation signals, and higher signal-to-noise ratios will be required in the future. However, in a transmission system that uses a typical single mode fiber (SMF), transmission capacity is expected to saturate after reaching 100 Tbit/sec due to theoretical limitations and input power limitations caused by non-linear effects. This makes further capacity increases difficult.

There is a demand for a medium that achieves an innovative increase in transmission capacity to further increase transmission capacity in the future. In light of this, mode-multiplexed transmission using multi-mode fibers (MMF) has garnered attention. Multi-mode fibers are expected to improve the signal-to-noise ratio and space utilization efficiency through using a plurality of propagation modes in an optical fiber as a channel. Higher-order modes that propagates through the fiber has contributed to signal degradation. However, the active use of higher order modes has been studied for expanding digital signal processing and multiplexing technology (see, for example, NPL 1 and 2).

In addition to increasing transmission capacity, studies have also been conducted to increase the range of mode-multiplexed transmission. There have been reports of transmission across 527 km using a non-coupled 12 core fiber capable of three-mode propagation (see, for example, see NPL 3).

### CITATION LIST

### Non Patent Literature

NPL 1: N. Hanzawa et al., “Demonstration of Mode-Division multiplexing Transmission Over 10 km Two-mode Fiber with Mode Coupler” OFC2011, paper OWA4
NPL 2: T. Sakamoto et al., “Modal Dispersion Technique for Long-haul Transmission over Few-mode Fiber with SIMO Configuration” ECOC2011, We.10.P1.82
NPL 3: K. Shibahara et al., “Dense SDM (12-Core×3-Mode) Transmission Over 527 km With 33.2-ns Mode-Dispersion Employing Low-Complexity Parallel MIMO Frequency-Domain Equalization,” J. Lightw. Technol., vol. 34, no. 1 (2016).
NPL 4: X. Zhao et al., “Mode converter based on the long-period fiber gratings written in the six-mode fiber,” ICOCN, 2017.
NPL 5: T. Fujisawa et al., “One chip, PLC three-mode exchanger based on symmetric and asymmetric directional couplers with integrated mode rotator,” OFC 2017, Paper.W 1b.2.
NPL 6: M. Salsi et al., “A Six-mode erbium-doped fiber amplifier,” ECOC 2012, Paper. Th.3.A.6.
NPL 7: Y. Jung et al., “Reconfigurable modal gain control of a few-mode EDFA supporting six spatial modes,” IEEE Photonics Technology Letters, vol. 26, No. 11, June (2014)

### SUMMARY OF THE INVENTION

### Technical Problem

When increasing the range of mode-multiplexed transmission, differential modal attenuation (DMA), which occurs on transmission lines, and differential modal gain (DMG), which occurs in an optical amplifier, are important for achieving long-range transmission. In NPL 3, mode dependent loss (MDL) including DMA and DMG is adjusted to be 0.2 dB or less in one span to achieve long-range transmission. In NPL 3, a spatial filter-type differential modal attenuation compensator is used to impart a loss approximately 3 dB larger to an LP01 mode than an LP11 mode, thereby contributing to the reduction of MDL.

However, a spatial-type gain equalizer such as that described in NPL 3 uses, in addition to fibers, a lens or a filter for imparting loss to a particular mode. Thus, the spatial gain equalizer has a complicated structure and precision alignment work is required to inhibit crosstalk between propagation modes, which is a problem.

In order to solve the problem described above, an object of the present invention is to provide a differential modal attenuation compensation fiber that has a simple structure and can reduce MDL while eliminating the need for precise alignment work, an optical amplifier, and a transmission line design method.

### Means for Solving the Problem

In order to achieve the above object, in the differential modal attenuation compensation fiber according to the present invention, a cavity portion or a ring-shaped high refractive index portion is formed in the core of an optical fiber to impart excess loss to a desired propagation mode.

The differential modal attenuation compensation fiber according to the present invention is a differential modal attenuation compensation fiber inserted into an optical fiber having a propagation mode count of N (N is an integer of 2 or more), the differential modal attenuation compensation fiber including:

a cladding portion; and
a core portion, the core portion having a radius a1, and a specific refractive index difference between the cladding portion and the core portion being Δ1, and
further including a first section and a second section along a propagation direction of light, and in which:
in the first section, part of a region of the core portion in a cross-section is formed with a cavity portion having a radius a2 (a2<a1),
in the second section, a cavity portion is not formed in a region of the core portion in a cross-section, and
among the propagation modes, greater loss is imparted to a particular propagation mode than to other propagation modes.

The differential modal attenuation compensation fiber has a simple structure because no spatial optical element is used. As a result, the present invention can provide a differential modal attenuation compensation fiber that has a simple structure and can reduce MDL while eliminating the need for precise alignment work.

In terms of specific parameters of the differential modal attenuation compensation fiber, in an XY plane where the radius a1 of the core portion is the X-axis and the specific refractive index difference Δ1 is the Y-axis, and in a region surrounded by a polygon having vertices of

### A1(5.6,0.65)

### B1(5.4,0.55)

### C1(5.33,0.53)

### D1(5.5,0.51)

### E1(6.0,0.45)

### F1(6.5,0.41)

### G1(7.0,0.38)

### H1(7.55,0.36)

### I1(7.0,0.42)

### J1(6.5,0.48)

### K1(6.0,0.575),

the radius a1 of the core portion and the specific refractive index difference Δ1 are present, and
the radius a2 of the cavity portion is set satisfying a2/a1<0.235.

The differential modal attenuation compensation fiber can transmit LP01 and LP11 modes in a C-band wavelength (1530 to 1565 nm) and can impart a large loss to the LP01 mode while minimizing loss in the LP11 mode.

Another differential modal attenuation compensation fiber according to the present invention is a differential modal attenuation compensation fiber inserted into an optical fiber having a propagation mode count of N (N is an integer of 2 or more), the differential modal attenuation compensation fiber including:

a cladding portion; and
a core portion, the core portion having a radius a1, and a specific refractive index difference between the cladding portion and the core portion being Δ1, and
further including a first section and a second section along a propagation direction of light, in which:
in the first section, a region of the core portion in a cross-section is formed with a ring-shaped high refractive index portion having an inner ring diameter a2 and an outer ring diameter a3 (a2<a3<a1), where a specific refractive index difference between the ring-shaped high refractive index portion and the cladding portion is Δ2,
in the second section, a ring-shaped high refractive index portion is not formed in a region of the core portion in a cross-section, and
among the propagation modes, greater loss is imparted to a particular propagation mode than to other propagation modes.

The differential modal attenuation compensation fiber has a simple structure because no spatial optical element is used. As a result, the present invention can provide a differential modal attenuation compensation fiber that has a simple structure and can reduce MDL while eliminating the need for precise alignment work.

In terms of specific parameters of the differential modal attenuation compensation fiber, in an XY plane where the radius a1 of the core portion is the X-axis and the specific refractive index difference Δ1 is the Y-axis, and

in a region surrounded by a polygon having vertices of

### A2(6.0,1.02)

### B2(5.9,0.95)

### C2(6.5,0.80)

### D2(7.0,0.71)

### E2(7.75,0.61)

### F2(7.0,0.75)

### G2(6.5,0.88),

the radius a1 of the core portion and the specific refractive index difference Δ1 are present, and
the radius a2 of the ring-shaped high refractive index portion and the specific refractive index difference Δ2 are set satisfying −0.02 (Δ2−1)+0.22<a2/a1<−0.19 (Δ2−Δ1)+0.41.

This differential modal attenuation compensation fiber can transmit LP01, LP11, LP21, and LP02 modes in a C-band wavelength (1530 to 1565 nm) and impart a large loss to the LP11 mode while minimizing loss in the LP01, LP21, and LP02 modes.

In terms of specific parameters of the differential modal attenuation compensation fiber, in an XY plane where the radius a1 of the core portion is the X-axis and the specific refractive index difference Δ1 is the Y-axis, and

in a region surrounded by a polygon having vertices of

### A2(6.0,1.02)

### B2(5.9,0.95)

### C2(6.5,0.80)

### D2(7.0,0.71)

### E2(7.75,0.61)

### F2(7.0,0.75)

### G2(6.5,0.88),

the radius a1 of the core portion and the specific refractive index difference Δ1 are present, and
the radius a2 of the ring-shaped high refractive index portion and the specific refractive index difference Δ2 are set satisfying X<a2/a1<−0.09 (Δ2−Δ1)+0.56,
where X=−0.04 (Δ2−Δ1)+0.35 when Δ2−Δ1<0.4,
X=0.35 (Δ2−Δ1)+0.20 when 0.4<Δ2−Δ1<0.6, and
X=0.07 (Δ2−Δ1)+0.36 when 0.6<Δ2−Δ1<1.2.

This differential modal attenuation compensation fiber can transmit LP01, LP11, LP21, and LP02 modes in a C-band wavelength (1530 to 1565 nm) and impart a large loss to the LP21 mode while minimizing loss in the LP01, LP11, and LP02 modes.

The differential modal attenuation compensation fiber according to the present invention further includes a mode converter configured to convert one of the other propagation modes and the particular mode at a stage before the first section. When excess loss cannot be imparted to a desired propagation mode due to structural reasons, the desired propagation mode is converted in a previous stage to a propagation mode to which excess loss can be imparted such that excess loss can be imparted to the desired propagation mode.

An optical amplifier according to the present invention includes:

an amplification optical fiber configured to amplify signal light that propagates through an optical fiber having a propagation mode count of N (N is an integer of 2 or more);
an excitation light source configured to transmit excitation light that excites the amplification optical fiber; and
at least the differential attenuation compensation fibers of any one of claims 1 to 6, the differential attenuation compensation fiber receiving input of signal light that has passed through the amplification fiber.

Because the optical amplifier includes the differential modal attenuation compensation fiber, the differential modal gain can be reduced.

A transmission line design method according to the present invention includes: acquiring gain of individual propagation modes of an optical amplifier configured to amplify signal light propagating through an optical fiber having a propagation mode count of N (N is an integer of 2 or more);

calculating a differential gain ΔG_{LPmn} (mn is a mode number) between a propagation mode having the smallest gain and other propagation modes among the gain acquired in the gain acquisition step;
preparing nᵢ attenuation compensators i (i is a natural number no greater than N−1) configured to impart excess loss to one of the other propagation modes, and acquiring loss Δ_{i_LPmn} imparted to each propagation mode (LPmn) for each attenuation compensator i; and
calculating a sum (ΔDMG_{LPmn}) of gain of the optical amplifier and loss imparted by all the attenuation compensators i for each propagation mode, and finding the number nᵢ of attenuation compensators i at which (a) the ΔDMG_{LPmn} of all the attenuation compensators is 10 dB or less, and (b) a differential MDL between maximum and minimum values of the ΔDMG_{LPmn} is at a minimum.
With this transmission line design method, it is possible to design a transmission line in which MDL is reduced.

### Effects of the Invention

The present invention can provide a differential modal attenuation compensation fiber that has a simple structure and can reduce MDL while eliminating the need for precise alignment work, an optical amplifier, and a transmission line design method.

### BRIEF DESCRIPTION OF DRAWINGS

FIG. 1 is a diagram illustrating a refractive index profile of a differential modal attenuation compensation fiber according to the present invention.

FIG. 2 is a diagram illustrating the location of a cavity portion and electric field distribution in each mode in the differential modal attenuation compensation fiber according to the present invention.

FIG. 3 is a diagram illustrating the differential modal attenuation compensation fiber according to the present invention.

FIG. 4 is a diagram illustrating the structure of the differential modal attenuation compensation fiber and the relationship between loss according to the present invention.

FIG. 5 is a diagram illustrating a calculation result for a region where excess loss in a permitted LP01 mode is 0.1 dB in the differential modal attenuation compensation fiber according to the present invention.

FIG. 6 is a diagram illustrating the differential modal attenuation compensation fiber according to the present invention.

FIG. 7 is a diagram illustrating the relationship between loss and the number of cavity portions in the differential modal attenuation compensation fiber according to the present invention.

FIG. 8 is a diagram illustrating a refractive index profile of the differential modal attenuation compensation fiber according to the present invention.

FIG. 9 is a diagram illustrating a region in the differential modal attenuation compensation fiber in which 4LP mode can propagate in a C-band wavelength according to the present invention.

FIG. 10 is a diagram illustrating the relationship between a ratio of an inner ring diameter of a ring-shaped high refractive index portion to a core radius and loss of each propagation mode in the differential modal attenuation compensation fiber according to the present invention.

FIG. 11 is a diagram illustrating a parameter range in which excess loss is imparted to an LP11 mode in the differential modal attenuation compensation fiber according to the present invention.

FIG. 12 is a diagram illustrating a parameter range in which excess loss is imparted to an LP21 mode in the differential modal attenuation compensation fiber according to the present invention.

FIG. 13 is a diagram illustrating the differential modal attenuation compensation fiber according to the present invention.

FIG. 14 is a diagram illustrating the relationship between a ratio of radius of a cavity portion to a core radius, and loss of each propagation mode in the differential modal attenuation compensation fiber according to the present invention.

FIG. 15 is a diagram illustrating an optical amplifier according to the present invention.

FIG. 16 is a diagram illustrating a transmission line design method according to the present invention.

### DESCRIPTION OF EMBODIMENTS

Hereinafter, embodiments of the present disclosure will be described with reference to the drawings. The embodiments described below are examples of the present disclosure, and the present disclosure is not limited to the following embodiments. In this specification and the drawings, constituent elements having the identical reference signs are assumed to be the same.

### First Embodiment

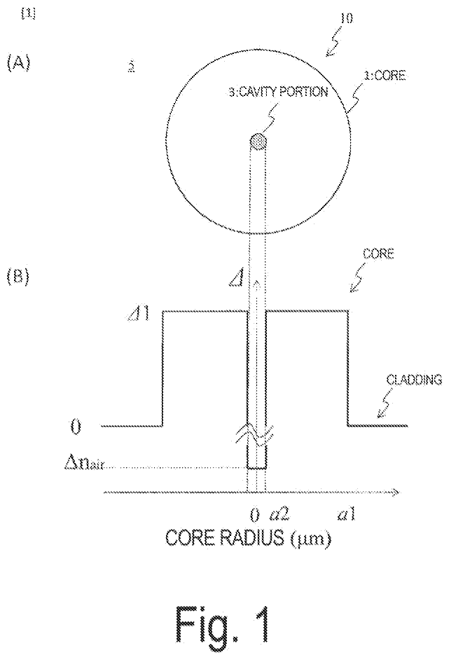

FIG. 1 is a diagram illustrating the structure of a differential modal attenuation compensation fiber 10 according to the present embodiment. The differential modal attenuation compensation fiber 10 is a differential modal attenuation compensation fiber inserted into an optical fiber having a propagation mode count of N (N is an integer of 2 or more), the differential modal attenuation compensation fiber 10 including:

a cladding portion 5; and
a core portion 1, the core portion having a radius a1, and a specific refractive index difference between the cladding portion 5 and the core portion 1 being Δ1, and
further including a first section and a second section along a propagation direction of light, in which:
in the first section, part of a region of the core portion 1 in a cross-section is formed with a cavity portion 3 having a radius a2 (a2<a1),
in the second section, a cavity portion is not formed in a region of the core portion 1 in a cross-section, and
among the N-number of propagation modes, greater loss is imparted to a particular propagation mode than to other propagation modes

FIG. 1(a) is a cross-sectional view of the first section of the differential modal attenuation compensation fiber 10. FIG. 1(b) illustrates refractive index distribution in a radial direction of the first section in the differential modal attenuation compensation fiber 10. The core radius is denoted as a1 and the specific refractive index difference of the core portion 1 with respect to the cladding portion 5 is denoted as Δ1. In the present embodiment, a step-shaped and cylindrical optical fiber is illustrated as an example, but other refractive index shapes and waveguide structures may also be considered for different effects.

In a multi-mode optical fiber, the fundamental mode generally exhibits stronger light confinement and lower propagation loss, including bending loss, than a higher-order mode. Therefore, in order to reduce MDL in a mode-multiplexed transmission system, it is necessary to consider a structure that imparts greater excess loss to the fundamental mode than to a higher order mode. In order to achieve such a structure, the present embodiment is an example including the cavity portion 3 at the center of the core portion 1.

The cavity portion 3 is a region corresponding to the inner radius a2 (0≤a2≤a1) of the core portion 1. Forming a cavity in a portion of the core profile makes it possible to control the electric field distribution of a particular mode propagating through the fiber, and this allows different losses to be imparted to different propagation modes at an interface between the cavity portion and a region without a cavity portion in the second section.

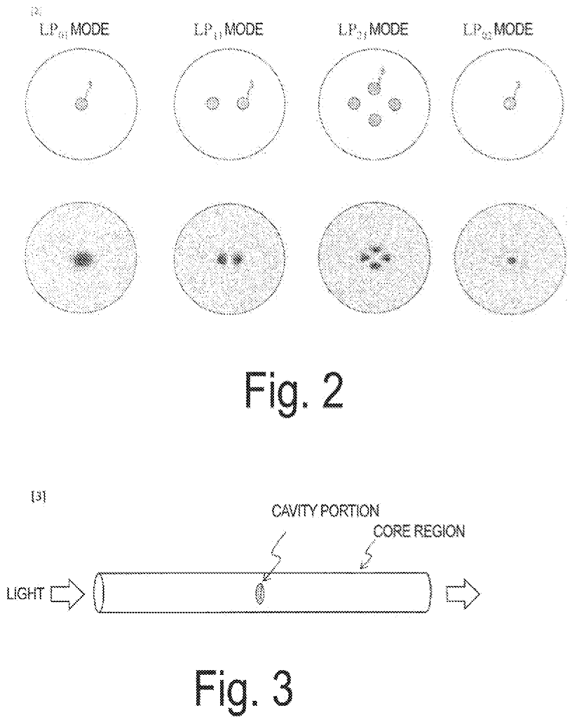

A known method for forming a cavity in an optical fiber involves irradiating an optical waveguide with a femtosecond laser. In this method, irradiation conditions are controlled to induce refractive index fluctuation and form a cavity portion region. Note that, while the differential modal attenuation compensation fiber 10 is disposed centered about the cavity portion 3, any amount of excess loss is imparted to any mode, and hence the cavity portion need not be disposed at the center and can be disposed at any position. As illustrated in FIG. 2, disposing the cavity portion 3 at a position where the strength of the electric field of each mode increases makes it possible to impart excess loss to any mode.

The relationship between a2 and propagation loss in an optical fiber that supports 2LP mode propagation will be described below.

FIG. 3 is a diagram illustrating the entire differential modal attenuation compensation fiber 10. The differential modal attenuation compensation fiber 10 has a structure including one cavity portion 3 at one portion in the longitudinal direction of the differential modal attenuation compensation fiber 10. To calculate connection loss, the distribution of electric field propagating through a core structure including the cavity portion (first section) and a core structure not including the cavity portion (second section) is calculated using a finite element method to determine overlap between the electric field distributions. Note that the connection loss can be similarly calculated for an optical fiber in which more than 2LP mode propagates. Note that the width of the cavity portion 3 (length in the longitudinal direction of the optical fiber) is approximately several μm.

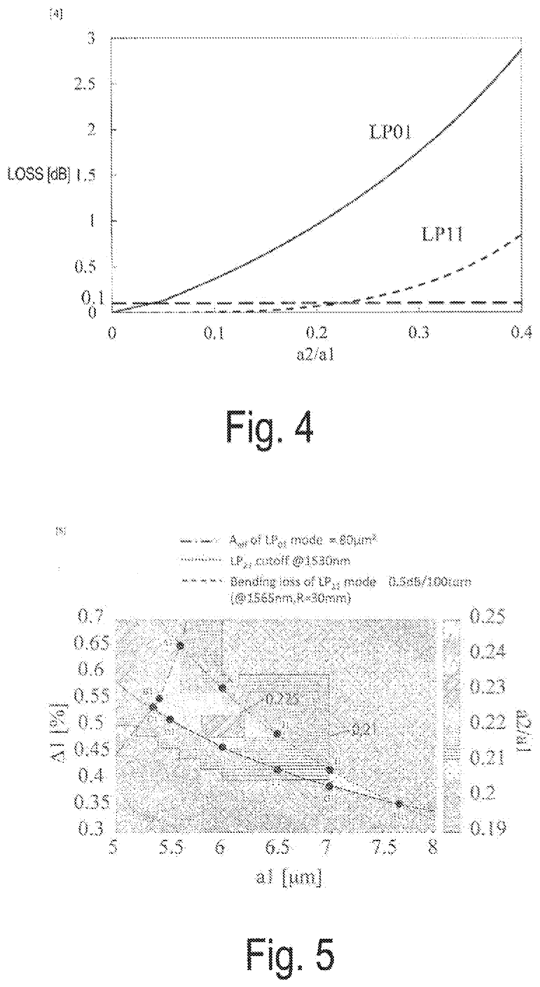

FIG. 4 is a diagram illustrating the relationship between connection loss of LP01 and LP11 modes and a2/a1. Here, a1 is 7 μm and Δ1 is 0.4%. It can be seen that loss increases as a2/a1 increases and varies based on the propagation mode. Minimizing excess loss other than that of a desired mode (here, the LP01 mode) is desired as a characteristic of the differential modal attenuation compensation fiber. It can be seen from FIG. 4 that a2/a1 needs to be 0.22 or less in order to keep excess loss other than that of the desired mode at 0.1 dB or less.

FIG. 5 is a diagram illustrating the value of a2/a1 where permitted excess loss of the LP11 mode is 0.1 dB in an XY plane with a1 as the X-axis and Δ1 as the Y-axis. In FIG. 5, the dotted line indicates the theoretical cutoff of the LP21 mode at a wavelength of 1530 nm (LP21 does not propagate in the region below the dotted line) and the dashed line indicates the region where bending loss of the LP11 mode at a wavelength of 1565 nm and when R=30 mm is 0.5 dB/100 turn (region above the dashed line). 2LP-mode transmission is possible in the C-band (wavelength of 1530 to 1565 nm) in a region sandwiched between both these regions. Note that the dot-dash line indicates a region (below the dot-dash line) where the effective cross-sectional area of the LP01 mode is 80 μm² or more.

The XY plane of FIG. 5 illustrates the value of a2/a1 where excess loss of the LP11 mode is 0.1 dB or less, and the value of a2/a1 refers to the maximum value of the size of the cavity portion 3. When the effective cross-sectional area of the LP01 mode is 80 μm² or more, Δ1 is desirably 0.65% or less. Thus, setting a2/a1<0.235 in a range where 5.5 μm<a1<7.5 μm and 0.35%<Δ1<0.65% makes it possible to compensate for the difference in loss while suppressing loss of the LP11 mode.

More precisely, in an XY plane where the radius a1 of the core section is the X-axis and the specific refractive index difference Δ1 is the Y-axis, in a region surrounded by a polygon having vertices of A1(5.6,0.65) B1(5.4,0.55) C1(5.33,0.53) D1(5.5,0.51) E1(6.0,0.45) F1(6.5,0.41) G1(7.0,0.38) H1(7.55,0.36) I1(7.0,0.42) J1(6.5,0.48) K1(6.0,0.575), the radius a1 of the core section and the specific refractive index difference Δ1 are present and the radius a2 of the cavity portion is set satisfying a2/a1<0.235.

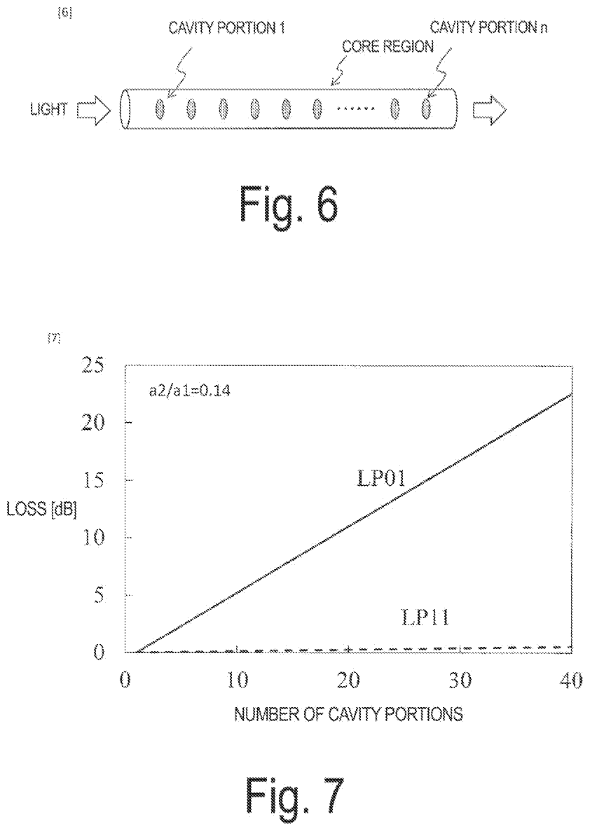

However, in a region where a2/a1 is 0.235 or less, the cavity portion 3 limits the excess loss imparted to the LP01 mode. Thus, as illustrated in FIG. 6, a plurality of cavity portions 3 each having a2/a1 (for example, 0.22 or less) with a small excess loss to the LP11 mode are aligned in the longitudinal direction of the optical fiber (i.e., the first section and the second section are repeated multiple times) to impart any type of loss to the LP01 mode while suppressing excess loss to the LP11 mode.

FIG. 7 is a diagram illustrating the relationship between the number of cavity portions 3 and the loss of each mode when a2/a1=0.14. It can be seen from FIG. 7 that increasing the number of cavity portions 3 imparts loss of 20 dB or more to the LP01 mode while maintaining loss to the LP11 mode at 0.6 dB or less.

As described above, in the relationship between the differential modal attenuation compensation fiber 10 and the radius of the cavity portion 3 illustrated in FIG. 5, reducing the diameter of each cavity portion 3 and adjusting the number of cavity portions 3 disposed in the longitudinal direction increases flexibility of the design of the MDL compensation range.

### Second Embodiment

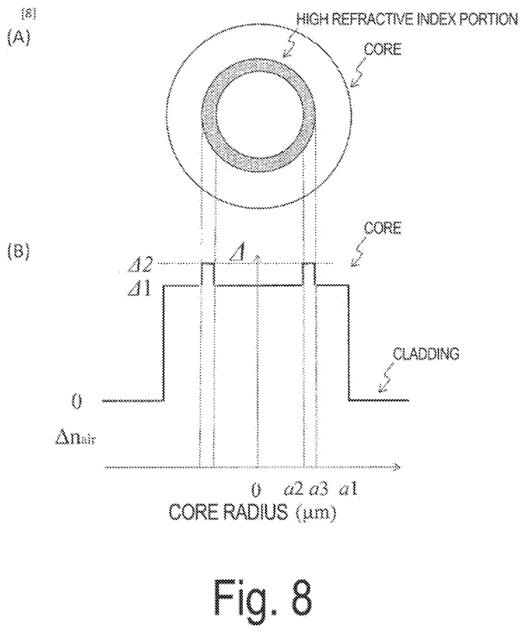

FIG. 8 is a diagram illustrating the structure of a differential modal attenuation compensation fiber 20 according to the present embodiment. The differential modal attenuation compensation fiber 20 is a differential modal attenuation compensation fiber inserted into an optical fiber having a propagation mode count of N (N is an integer of 2 or more), the differential modal attenuation compensation fiber including:

a cladding portion 5; and
a core portion 1, the core portion having a radius a1, and a specific refractive index difference between the cladding portion 5 and the core portion 1 being Δ1, and
further including a first section and a second section along a propagation direction of light, in which:
in the first section, a region of the core portion 1 in a cross-section is formed with a ring-shaped high refractive index portion 7 having an inner ring diameter a2 and an outer ring diameter a3 (a2<a3<a1), where a specific refractive index difference between the ring-shaped high refractive index portion and the cladding portion 5 is Δ2,
in the second section, a ring-shaped high refractive index portion is not formed in a region of the core portion 1 in a cross-section, and
among the propagation modes, greater loss is imparted to a particular propagation mode than to other propagation modes

FIG. 8(a) is a cross-sectional view of the first section of the differential modal attenuation compensation fiber 20. FIG. 8(b) illustrates refractive index distribution in the radial direction of the first section of the differential modal attenuation compensation fiber 20. The core radius is denoted as a1, the specific refractive index difference between the core portion 1 and the cladding portion 5 is denoted as Δ1, the inner ring diameter of the high refractive index portion 7 of the specific refractive index difference Δ2 with respect to the cladding portion 5 is denoted as a2, and the outer ring diameter is denoted as a3. By providing the ring-shaped high refractive index portion in a portion of the core profile in this way, electric field distribution of a particular mode propagating through the fiber can be controlled, and this allows different losses to be imparted to different propagation modes at an interface between the high refractive index portion and a region without the high refractive index.

The core shape of the differential modal attenuation compensation fiber 20 is formed by spinning similar types of optical fiber base materials. Alternatively, the core shape can be achieved by irradiating an optical fiber or a pure quartz fine wire with a femtosecond laser in the same manner as in the first embodiment.

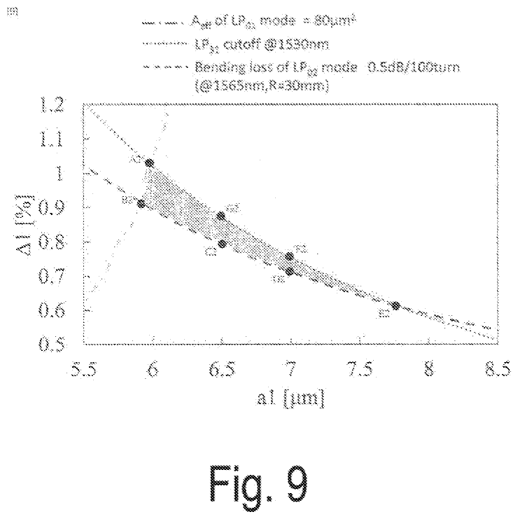

FIG. 9 illustrates a region in which the differential modal attenuation compensation fiber 20 can propagate 4LP mode in an XY plane where the core diameter a1 is the X-axis and the core specific refractive index difference Δ1 is the Y-axis. In FIG. 9, the dotted line indicates the theoretical cutoff of an LP31 mode at a wavelength of 1530 nm (LP31 does not propagate in the region below the dotted line) and the dashed line indicates a region where bending loss of the LP02 mode at a wavelength of 1565 nm and when R=30 mm is 0.5 dB/100 turn (region above the dashed line). 4LP-mode transmission is possible in the C-band (wavelength of 1530 to 1565 nm) in a region sandwiched between both these regions. Note that the dot-dash line indicates a region (below the dot-dash line) where the effective cross-sectional area of the LP01 mode is 80 μm² or more.

To describe the range in which 4LP-mode transmission is possible in more detail, in an XY plane where the radius a1 of the core section 1 is the X-axis and the specific refractive index difference Δ1 is the Y-axis, the differential modal attenuation compensation fiber 20 is designed such that the radius a1 of the core section 1 and the specific refractive index difference Δ1 are present in a region surrounded by a polygon having vertices of A2(6.0,1.02) B2(5.9,0.95) C2(6.5,0.80) D2(7.0,0.71) E2(7.75,0.61) F2(7.0,0.75) G2(6.5,0.88).

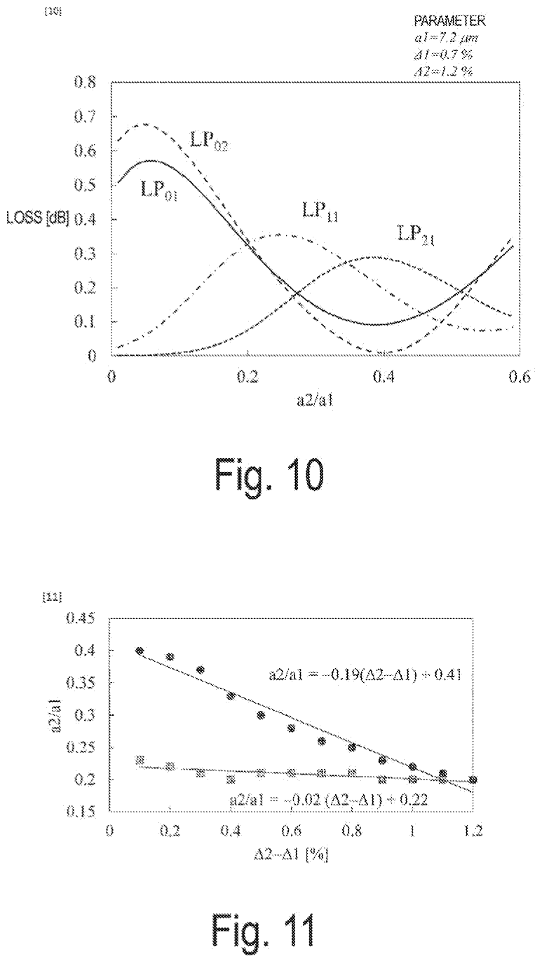

FIG. 10 is a diagram illustrating the relationship between the loss of each mode and a2/a1 when the structure of the differential modal attenuation compensation fiber 20 is set such that a1=7.2 μm, a2−a3=2 μm, Δ1=0.7%, and Δ2=1.2%. It can be seen that the loss of each mode varies sinusoidally based on how a2/a1 changes. In order to utilize the differential modal attenuation compensation fiber 20 as a mode compensator, it is important that loss of the mode to be imparted with excess loss is higher than that of other modes, and that a maximum value ΔL_{LPmn} of differential modal attenuation between modes other than the mode to be imparted with excess loss is small. Here, LPmn indicates the mode to be imparted with excess loss. As illustrated in FIG. 6, assuming that a plurality of the high refractive index portions 7 are arranged in the longitudinal direction (i.e., the first section and the second section are repeated a plurality of times), it is preferable that ΔL_{LPmn} be suppressed to 0.1 dB or less. From FIG. 10, the difference in loss between the LP11 mode and other modes can be maximized while suppressing ΔL_{LP11} to, for example, 0.1 dB or less assuming that a2/a1=0.27. In addition, the difference in loss between the LP21 mode loss and other modes can be maximized while suppressing ΔLLP21 to 0.1 dB or less assuming that a2/a1=0.46.

It will now be described that similar effects can be obtained by changing the structures a1, Δ1, and Δ2 of the differential modal attenuation compensation fiber 20. FIG. 11 is a diagram illustrating the relationship between a2/a1 and Δ2−Δ1, where ΔL_{LP11} is 0.1 dB or less and the difference in loss between the LP11 mode and other modes is maximized. FIG. 11 illustrates the maximum range of a2/a1 when 6.0<a1<8.0 and 0.6<Δ1<1.1 from the range in which the 4LP mode described in FIG. 9 can propagate. From FIG. 11, it is possible to configure the differential modal attenuation compensation fiber 20 in which excess loss can be imparted to the LP11 mode while suppressing ΔL_{LP11} to 0.1 dB or less in a region satisfying the following formula.

−0.02(Δ2−Δ1)+0.22<a2/a1<−0.19(Δ2−Δ1)+0.41, (Formula 1)

where 6.0<a1<8.0 and 0.6<Δ1<1.1.

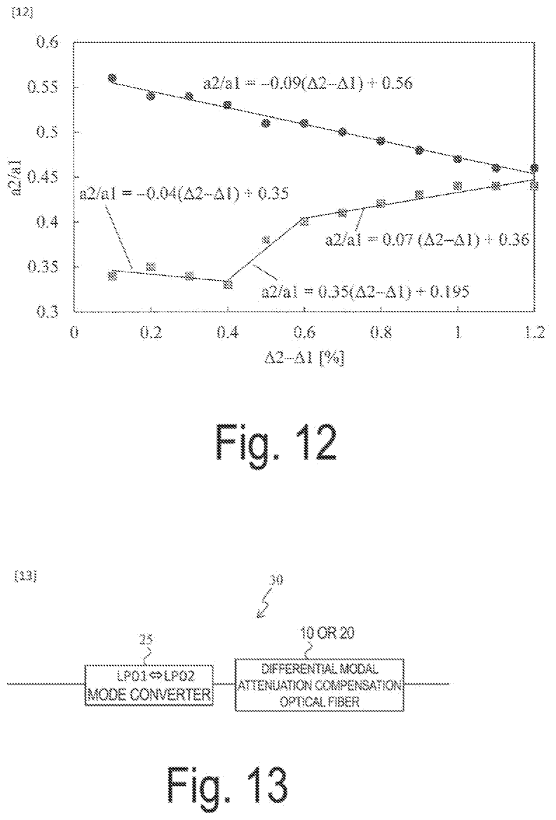

Similarly, FIG. 12 is a diagram illustrating the relationship between a2/a1 and Δ2−Δ1 where ΔL_{LP21} is 0.1 dB or less and the difference in loss between the LP21 mode and other modes is maximized. FIG. 12 also illustrates the maximum range of a2/a1 when 6.0<a1<8.0 and 0.6<Δ1<1.1 from the range in which the 4LP mode described in FIG. 9 can propagate. From FIG. 12, it is possible to configure the differential modal attenuation compensation fiber 20 in which excess loss can be imparted to the LP21 mode while suppressing the ΔL_{LP21} to 0.1 dB or less in a region satisfying the following formula.

X<a2/a1<−0.09(Δ2−Δ1)+0.56 (Formula 2)

Here, X has the following value.
X=−0.04 (Δ2−Δ1)+0.35 when Δ2−Δ1<0.4,
X=0.35 (Δ2−Δ1)+0.20 when 0.4<Δ2−Δ1<0.6, and
X=0.07 (Δ2−Δ1)+0.36 when 0.6<Δ2−Δ1<1.2.
Where 6.0<a1<8.0 and 0.6<Δ1<1.1.

As in the first embodiment, adjusting the number of high refractive index portions 7 arranged in the longitudinal direction of the optical fiber as in FIG. 6 with the parameters (a1, a2, a3, Δ1, Δ2) of the differential modal attenuation compensation fiber 20 set such that excess loss to the LPmn mode is small makes design of the MDL compensation range more flexible.

Further, the present embodiment deals with a structure in which the center of the optical fiber coincides with the center of the high refractive index portion 7, but it is also possible to form the high refractive index portion 7 such that the center does not coincide with the center of the optical fiber. For example, the present embodiment can also be applied to a multi-core structure in which the cladding is provided with a plurality of optical waveguides, and the high refractive index portion 7 can be formed for each core such that the center coincides with the center of each core.

### Third Embodiment

As described above, MDM transmission is more susceptible to loss in higher-order modes. Thus, MDL can be compensated for by imparting more excess loss to lower-order modes than higher-order modes. However, it is difficult to impart the greatest amount of loss to the LP01 mode in the region illustrated in FIG. 9. Thus, converting the LP01 mode to another higher-order mode before reaching the differential modal attenuation compensation fiber 20 and imparting excess loss to the converted higher-order mode makes it possible to impart excess loss to the LP01 mode before mode conversion.

FIG. 13 is a diagram illustrating a differential modal attenuation compensator 30 of the present embodiment. The differential modal attenuation compensator 30 includes a mode converter 25 configured to convert one of the other propagation modes and the particular mode prior to the differential modal attenuation compensation fiber (10 or 20).

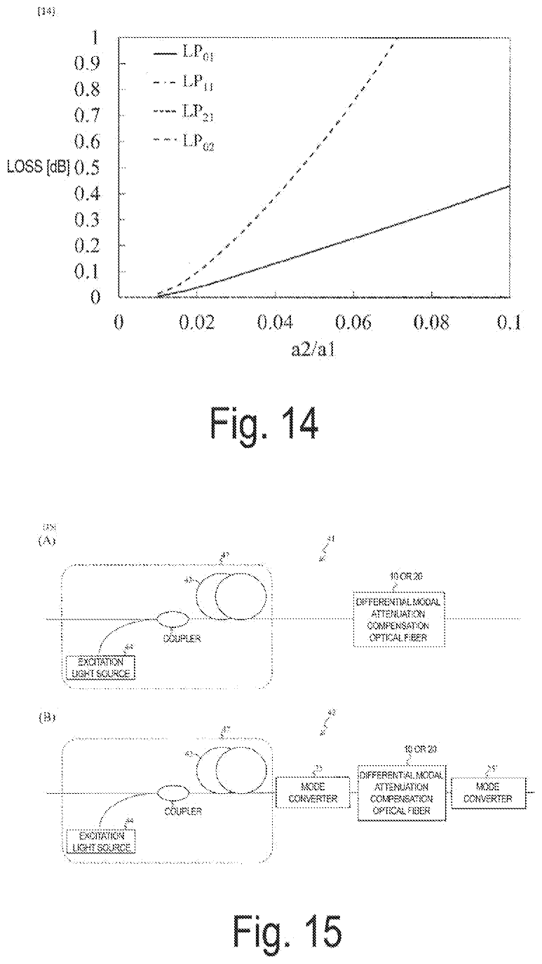

An example in which the differential modal attenuation compensation fiber 10 is used is illustrated. The differential modal attenuation compensation fiber 10 of the present embodiment is designed to allow 4LP-mode propagation. FIG. 14 is a diagram illustrating the relationship between loss of LP01, LP11, LP21, LP02 modes and a2 in the differential modal attenuation compensation fiber 10. Here, a1=10 μm and Δ1=0.4%.

As illustrated in FIG. 14, it can be seen that loss of the LP02 mode is the highest. Thus, the mode converter 25 capable of converting the mode before the differential attenuation compensation fiber 10 is disposed to convert the LP01 mode to the LP02 mode and the LP02 mode to the LP01 mode. The arrangement of the mode converter 25 determines whether excess loss higher than that of other modes can be imparted to the LP01 mode prior to mode conversion.

For example, with a structure where a2/a1=0.02, ΔL_{LP02} can be suppressed to 0.1 dB or less while imparting excess loss of 0.12 dB to the LP02 mode compared to other modes. Note that the LP02 mode can be returned to the LP01 mode and the LP01 mode can be returned to the LP02 mode by inserting another mode converter in a stage subsequent to the differential attenuation compensation fiber 10.

The mode converter 25 for the LP01 and LP02 modes can be configured by, for example, using a long-period fiber grating structure (see, for example, NPL 4). The mode converter 25 is not limited to long-period grating and may be replaced by a device having the mode conversion function described in NPL 5.

In the present embodiment, mode conversion between LP01 and LP02 has been described, but a similar effect can be achieved by selecting a mode in which conversion is performed according to the LPmn of the differential attenuation compensation fiber.

### Fourth Embodiment

FIG. 15 is a diagram illustrating a multi-mode optical amplifier (41, 42) including a differential attenuation compensation fiber. The optical amplifier (41, 42) includes:

an amplification optical fiber 43 configured to amplify signal light that propagates through an optical fiber having a propagation mode count of N (N is an integer of 2 or more);
an excitation light source 44 configured to transmit excitation light that excites the amplification optical fiber 43; and
at least one of the differential attenuation compensation fibers (10, 20), the differential attenuation compensation fiber receiving input of signal light that has passed through the amplification fiber 43.

In an optical amplification portion 47 for multi-mode transmission, differential modal gain is generated due to the rare earth distribution of the amplification fiber and excitation light conditions (see, for example, NPL 6 and 7). Thus, it is necessary to impart loss to compensate for the differential modal gain of the optical amplification portion 47. For example, the differential attenuation compensation fiber 20 that imparts high excess loss to the LP11 mode, the differential attenuation compensation fiber 20 that imparts high excess loss to the LP21 mode, and the differential attenuation compensation fiber 10 that imparts high excess loss to the LP02 mode described in the first and second embodiments, and the mode converter 25 for the LP01 and LP02 modes described in the third embodiment may be combined to compensate for the differential modal gain.

Differential modal gain in a 4LP-mode optical amplifier can be reduced by designing a characteristic that is inversely correlated with the gain characteristic of the optical amplification portion 47. If the excess loss characteristic of the differential attenuation compensation fiber is a characteristic inversely correlated with the gain characteristic of the optical amplification portion 47, the differential attenuation compensation fiber need only be connected in the stage subsequent to the optical amplification portion 47 (optical amplifier 41 in FIG. 15(a)). However, if the excess loss characteristic of a single differential attenuation compensation fiber is not a characteristic inversely correlated with the gain characteristic of the optical amplification portion 47, a plurality of differential attenuation compensation fibers and mode converters are combined to create a characteristic inversely correlated with the gain characteristic of the optical amplification portion 47 as a result of the total of the combination (optical amplifier 42 in FIG. 15(b)).

### Fifth Embodiment

In the present embodiment, a transmission line design method is described in which the type and quantity of differential attenuation compensation fibers necessary for improving MDL are estimated for optical transmission lines having optical amplifiers (41, 42) and an optical amplification portion in which multi-mode transmission is performed.

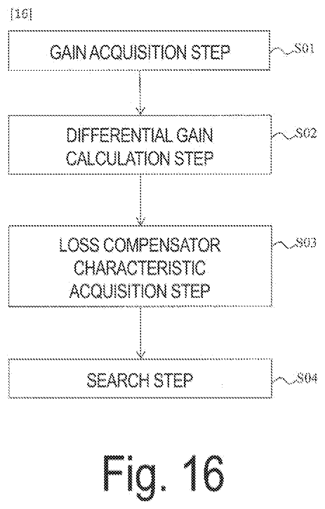

FIG. 16 is a flowchart illustrating the transmission line design method. The transmission line design method includes:

a gain acquisition step S01 of acquiring gain of each propagation mode of propagation modes of an optical amplifying portion configured to amplify signal light propagating through an optical fiber having a propagation mode count of N (N is an integer of 2 or more);
a differential gain calculation step S02 of calculating a differential gain ΔG_{LPmn} (mn is a mode number) between a propagation mode having the smallest gain and other propagation modes among the gain acquired in the gain acquisition step;
an attenuation compensator characteristic acquisition step S03 of preparing nᵢ attenuation compensators i (i is a natural number no greater than N−1) configured to impart excess loss to one of the other propagation modes, and acquiring loss Δ_{i_LPmn} imparted to each (LPmn) of the propagation modes for each attenuation compensator i; and
a search step S04 of calculating a sum (ΔDMG_{LPmn}) of gain of the optical amplifier and loss imparted by all the attenuation compensators i for each propagation mode, and finding the number nᵢ of attenuation compensators i at which (a) the ΔDMG_{LPmn} of all the attenuation compensators is 10 dB or less, and (b) a differential MDL between maximum and minimum values of the ΔDMG_{LPmn} is at a minimum.

(1) Gain Acquisition Step S01

First, the value of the gain of each propagation mode generated at the optical amplification portion (e.g., amplification optical fiber) is determined. The gain may be measured or obtained from specifications of the optical amplification portion.

(2) Differential Gain Calculation Step S02

If there are two propagation modes, the differential gain between the propagation modes is calculated. If there are three or more propagation modes, the differences in gain between each propagation mode and the mode with the lowest gain is calculated.

(3) Attenuation Compensator Characteristic Acquisition Step S03

If there are two propagation modes, the calculated differential gain is divided by differential attenuation of the compensator to determine the number of compensators.

If there are three or more propagation modes, a compensator is provided for each propagation mode other than the propagation mode with the smallest gain to impart excess loss to those modes, and a combination nᵢ of the number of compensators at which MDL is minimal is determined.

The transmission line design method will now be described in detail.

Note that the loss value described in the first to third embodiments is determined from overlap integration of electric field distributions and is a loss value of one connection point. When connecting the compensator with the fiber, mode mismatch occurs at two locations, that is, an incident portion and an exiting portion. Thus, a loss value that is twice as high is used below.

An example of compensating for gain at a wavelength of 1546 nm from the gain spectrum described in NPL 7 will be described.

### Gain Acquisition Step and Differential Gain Calculation Step

The gain at the optical amplifier increases in order of the modes LP01, LP11, LP21, and LP02. The differences in gain to LP02 with minimal gain are ΔG_{LP01}=4.1 dB, ΔG_{LP11}=2.0 dB, and ΔGLP21=0.4 dB, respectively.

Attenuation Compensator Characteristic Acquisition Step

When using an LP01 mode compensator as the compensator 1 having a structure where a2/a1=0.02 as illustrated in FIG. 14, and using an LP01/LP02 mode converter before and after, the loss of each mode is: (α_{1 LP01}, α_{1 LP11}, α_{1 LP21}, α_{1 LP02})=(0.195, 1.8×10⁻⁶, 2.6×10⁻⁶, 0.076).

The LP11, 21 mode compensators described in the second embodiment are used as the compensators 2 and 3. When a1=7.2 μm, a2−a3=2 μm, Δ1=0.7%, and Δ2=1.2% and using the structure of a2/a1=0.27 and a2/a1=0.46 in FIG. 9, respectively, the loss of each mode is (Δ_{2 LP01}, α_{2 LP11}, α_{2 LP21}, α_{2 LP02})=(0.376, 0.700, 0.359, 0.331), (α_{3 LP01}, α_{3 LP11}, α_{3 LP21}, α_{3 LP02})=(0.272, 0.223, 0.473, 0.144).

Search Step

The sum (ΔDMG_{LPmn}) of gain of the amplifier and the excess loss imparted by the compensator for each propagation mode is calculated (Math. 3). Then, the differential MDL between the maximum and minimum values of the excess losses is used to calculate the number (nᵢ) of each compensator such that at least the sum of the losses of each mode is minimal in a region of 10 dB or less (Math. 4).

$$\begin{matrix} [ Math . 3 ] & \\ Δ {DMG}_{LP 0 \; 1} = Δ {G}_{LP 01} - ( {n}_{1} {α}_{{1}_{LP 01}} + {n}_{2} {α}_{{2}_{LP 01}} + {n}_{3} {α}_{{3}_{LP 01}} ) \\ Δ {DMG}_{LP 11} = Δ {G}_{LP 11} - ( {n}_{1} {α}_{{1}_{LP 11}} + {n}_{2} {α}_{{2}_{LP 11}} + {n}_{3} {α}_{{3}_{LP 11}} ) \\ Δ {DMG}_{LP 21} = Δ {G}_{LP 21} - ( {n}_{1} {α}_{{1}_{LP 21}} + {n}_{2} {α}_{{2}_{LP 21}} + {n}_{3} {α}_{{3}_{LP 21}} ) \\ Δ {DMG}_{LP 02} = Δ {G}_{LP 01} - ( {n}_{1} {α}_{{1}_{LP 02}} + {n}_{2} {α}_{{2}_{LP 02}} + {n}_{3} {α}_{{3}_{LP 02}} ) & ( 3 ) \\ MDL - max ( Δ {DMG}_{LP 0 \; 1} , Δ {DMG}_{LP 11} , Δ {DMG}_{LP 21} , Δ {DMG}_{LP 02} ) - min ( Δ {DMG}_{LP 0 \; 1} , Δ {DMG}_{LP 11} , Δ {DMG}_{LP 21} , Δ {DMG}_{LP 02} ) & ( 4 )\end{matrix}$$

When, for example, n₁=24, n₂=9, and n₃=6, MDL can be minimized and the differential modal gain described in NPL 7 can be suppressed to 0.075 dB.

### REFERENCE SIGNS LIST

1: Core
3: Cavity portion
5: Cladding
7: High refractive index portion
10, 20: Differential modal attenuation compensation fiber
25, 25′: Mode converter
30: Differential modal attenuation compensator
41, 42: Optical amplifier
43: Amplification optical fiber
44: Excitation light source
47: Optical amplification portion

1. A differential modal attenuation compensation fiber inserted into an optical fiber having a propagation mode count of N (N is an integer of 2 or more), the differential modal attenuation compensation fiber comprising:
a cladding portion; and
a core portion, the core portion having a radius a1, and a specific refractive index difference between the cladding portion and the core portion being Δ1, and
further including a first section and a second section along a propagation direction of light, wherein:
in the first section, part of a region of the core portion in a cross-section is formed with a cavity portion having a radius a2 (a2<a1),
in the second section, a cavity portion is not formed in a region of the core portion in a cross-section, and
among the propagation modes, greater loss is imparted to a particular propagation mode than to other propagation modes.

2. The differential modal attenuation compensation fiber according to claim 1,
wherein, in an XY plane where the radius a1 of the core portion is the X-axis and the specific refractive index difference Δ1 is the Y-axis, and
in a region surrounded by a polygon having vertices of
A1(5.6,0.65)
B1(5.4,0.55)
C1(5.33,0.53)
D1(5.5,0.51)
E1(6.0,0.45)
F1(6.5,0.41)
G1(7.0,0.38)
H1(7.55,0.36)
I1(7.0,0.42)
J1(6.5,0.48)
K1(6.0,0.575),
the radius a1 of the core portion and the specific refractive index difference Δ1 are present, and the radius a2 of the cavity portion is set satisfying a2/a1<0.235.

3. A differential modal attenuation compensation fiber inserted into an optical fiber having a propagation mode count of N (N is an integer of 2 or more), the differential modal attenuation compensation fiber comprising:
a cladding portion; and
a core portion, the core portion having a radius a1, and a specific refractive index difference between the cladding portion and the core portion being Δ1, and
further including a first section and a second section along a propagation direction of light, wherein:
in the first section, a region of the core portion in a cross-section is formed with a ring-shaped high refractive index portion having an inner ring diameter a2 and an outer ring diameter a3 (a2<a3<a1), where a specific refractive index difference between the ring-shaped high refractive index portion and the cladding portion is Δ2,
in the second section, a ring-shaped high refractive index portion is not formed in a region of the core portion in a cross-section, and
among the propagation modes, greater loss is imparted to a particular propagation mode than to other propagation modes.

4. The differential modal attenuation compensation fiber according to claim 3,
wherein, in an XY plane where the radius a1 of the core portion is the X-axis and the specific refractive index difference Δ1 is the Y-axis, and
in a region surrounded by a polygon having vertices of
A2(6.0,1.02)
B2(5.9,0.95)
C2(6.5,0.80)
D2(7.0,0.71)
E2(7.75,0.61)
F2(7.0,0.75)
G2(6.5,0.88),
the radius a1 of the core portion and the specific refractive index difference Δ1 are present, and the radius a2 of the ring-shaped high refractive index portion and the specific refractive index difference Δ2 are set satisfying −0.02 (Δ2−Δ1)+0.22<a2/a1<−0.19(Δ2−Δ1)+0.41.

5. The differential modal attenuation compensation fiber according to claim 3,
wherein, in an XY plane where the radius a1 of the core portion is the X-axis and the specific refractive index difference Δ1 is the Y-axis, and
in a region surrounded by a polygon having vertices of
A2(6.0,1.02)
B2(5.9,0.95)
C2(6.5,0.80)
D2(7.0,0.71)
E2(7.75,0.61)
F2(7.0,0.75)
G2(6.5,0.88),
the radius a1 of the core portion and the specific refractive index difference Δ1 are present, and the radius a2 of the ring-shaped high refractive index portion and the specific refractive index difference Δ2 are set satisfying X<a2/a1<−0.09 (Δ2−Δ1)+0.56,
where X=−0.04 (Δ2−Δ1)+0.35 when Δ2−Δ1<0.4,
X=0.35 (Δ2−Δ1)+0.20 when 0.4<Δ2−Δ1<0.6, and
X=0.07 (Δ2−Δ1)+0.36 when 0.6<Δ2−Δ1<1.2.

6. The differential modal attenuation compensation fiber according to claim 1, further comprising a mode converter configured to convert one of the other propagation modes and the particular mode at a stage before the first section.

7. An optical amplifier, comprising:
an amplification optical fiber configured to amplify signal light that propagates through an optical fiber having a propagation mode count of N (N is an integer of 2 or more);
an excitation light source configured to transmit excitation light that excites the amplification optical fiber; and
at least one of the differential modal attenuation compensation fibers of claim 1, the differential modal attenuation compensation fiber receiving input of signal light that has passed through the amplification optical fiber.

8. A transmission line design method comprising:
acquiring gain of each propagation mode of propagation modes of an optical amplifier configured to amplify signal light propagating through an optical fiber having a propagation mode count of N (N is an integer of 2 or more);
calculating a differential gain ΔG_{LPmn} (mn is a mode number) between a propagation mode having the smallest gain and other propagation modes among the gain acquired in the acquiring of the gain;
preparing nᵢ attenuation compensators i (i is a natural number no greater than N−1) configured to impart excess loss to one of the other propagation modes, and acquiring loss α_{i_LPmn} imparted to each (LPmn) of the propagation modes for each attenuation compensator i; and
calculating a sum (ΔDMG_{LPmn}) of gain of the optical amplifier and loss imparted by all the attenuation compensators i for each of the propagation modes, and finding the number nᵢ of attenuation compensators i at which (a) the ΔDMG_{LPmn} of all the attenuation compensators is 10 dB or less, and (b) a differential MDL between maximum and minimum values of the ΔDMG_{LPmn} is at a minimum.
